(19) United States
(12) Patent Application Publication
(10) Pub. No.: US 2006/0180677 A1
(43) Pub. Date: Aug. 17, 2006

(54) Agricultural compositions which enhance performance of pesticides applied through drift reducing nozzles

(76) Inventors: Greg M. McManic, Memphis, TN (US); Patrick M. McMullan, Cordova, TN (US)

Correspondence Address: SMITH, GAMBRELL & RUSSELL, LLP, 1230 PEACHTREE STREET, N.E., SUITE 3100, PROMENADE II, ATLANTA, GA, 30309-3592, US

(21) Appl. No.: 11/049,369

(22) Filed: Feb. 2, 2005

(51) Int. Cl. A01G 25/09; B05B 17/00

(52) U.S. Cl. 239/1

(57) ABSTRACT

A spray composition for applying to soil, plants or other agricultural substrate containing of at least one member selected from the group consisting of block copolymer of ethylene oxide and propylene oxide. An adjuvant can be a concentrate composition which can be diluted to form a tank mix containing a pesticide. The composition of the invention enhances the efficacy of an agrochemical and is applied through drift reduction nozzles to a desired substrate which can be a plant, soil or crop.

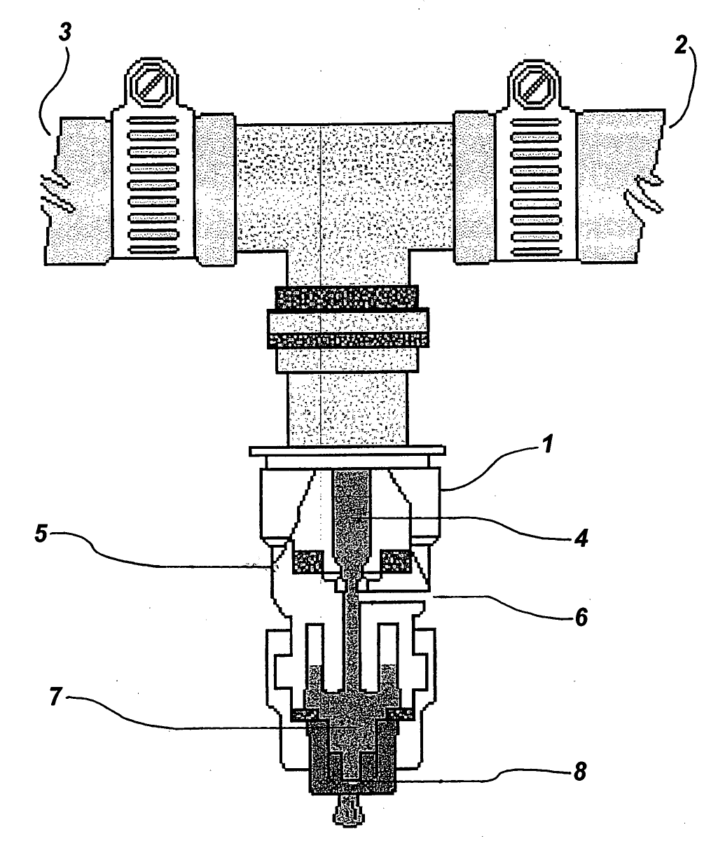

### INTRODUCTION AND BACKGROUND

The present invention relates to agricultural compositions which exhibit enhanced biological performance when added to spray mixtures containing pesticides and methods for applying agricultural spray mixtures to soil, plants or crops with drift reducing nozzles. The agricultural compositions of the present invention may be in the form of a water soluble solution, water emulsion, dispersion, or reverse phase emulsions, emulsifiable concentrates (EC) formulations, microemulsifiable concentrates (MEC), and the like.

It is well known in agriculture to apply various agrochemicals to growing areas by spraying. The growing areas may be crop areas in the field, which can be very large, or smaller growing areas such as those in greenhouses. The agrochemicals applied as sprays include fertilizers, herbicides, pesticides and the like. These materials can be applied to the target surfaces including the plants, crops and/or the soil. The agrochemicals must be applied via a carrier and reach the target surfaces to exert their desired biological effects.

The vast majority of known pesticides are applied to target surfaces through the use of hydraulic nozzles which are known and have been used for many years to apply agrochemicals to the target surfaces. Typically, the applicators use hydraulic nozzles which produce a fan-type of spray to apply the agrochemicals. One disadvantage of these nozzles is that a wide range of droplet sizes is produced, with a considerable portion of the spray droplets in the size range that is susceptible to spray drift. Spray droplets less than 200 microns in diameter are generally considered susceptible to drift. However, it is generally felt that smaller droplets are more biologically active than larger spray droplets. However, these smaller droplets are more susceptible to movement from the applied area to off-target areas, otherwise known as spray drift. Spray drift of pesticides is of utmost concern with respect to pesticide injury and the general public. As the term is used herein, “pesticide” includes herbicides.

Several new innovations in hydraulic nozzle design have been introduced, all targeted towards the reduction in spray drift. One such nozzle is the “TurboDrop” nozzle, in which the flow of liquid through the spray nozzle passes through a venturi restriction which causes air to be entrained with the liquid flow, the air being drawn in through an air inlet in the side of the spray nozzle assembly. The liquid and air mix together and air-filled droplets form when the mixed liquid and air pass out through the spray tip in a selected spray pattern. The air-filled droplets tend to drift much less than droplets produced by conventional hydraulic flat-fan spray tips. Another such nozzle is the “ComboJet DR” nozzle, in which the flow of liquid through the spray nozzle passes through a pre-orifice, which is of smaller diameter than the spray tip orifice. The pressure within the spray nozzle body is reduced and the droplets that are formed upon exiting the spray tip orifice tend to drift less than droplets produced by conventional hydraulic flat-fan spray tips. One other type of drift reduction nozzle is disclosed in U.S. Pat. No. 6,338,444. In this nozzle configuration air is drawn into the nozzle without the use of venturi valves and mixed with the spray mixture in a mixing region within the nozzle body before the spray mixture exits through the tip orifice.

The main objective of applying a pesticide spray is to obtain acceptable weed control while minimizing off-target spray drift. Research has shown that coarser pesticide sprays (i.e. pesticide sprays with a larger percentage of large droplets compared to smaller, driftable droplets) can be less effective than finer pesticide sprays (i.e. pesticide sprays with a larger percentage of smaller, driftable droplets compared to large droplets) (Knoche M (1994), Effect Of Droplet Size And Carrier Volume On The Performance Of Foliage-Applied Herbicides: Crop Protection 13: 163-178); Webb D A; Holloway P J; Western N (1999), Effects Of Some Surfactants On Foliar Impaction And Retention Of Monosize Water Droplets: Pesticide Science 55:382-385).

With the introduction of varying designs of drift reduction nozzles, such as air-induction nozzles, the effect of droplet size on efficacy is being expanded. For all nozzle types, performance is influenced by formulation (Miller P C H; Butler Ellis M C (2000)—Effects Of Formulation On Spray Nozzle Performance For Applications From Ground-Based Boom Sprayers: Crop Protection 19: 609-615) with the effects obtained with air-induction nozzles (such as the “TurboDrop” nozzle) being different to those obtained with conventional flat-fan nozzles (Butler Ellis M C; Tuck C R (2000)—The Variation In The Characteristics Of Air-Included Sprays With Adjuvants: Aspects of Applied Biology, 57, Pesticide Application, 155-162).

Jensen P. K. (1999)—Herbicide Performance With Low Volume Low-Drift And Air-Inclusion Nozzles: Proceedings of the BCPC Conference—Weeds, 453-460 and Powell E S; Orson J H; Miller P C H; Kudsk P; Mathiassen S (2003)—Defining the size of target for air induction nozzles: Proceedings of the BCPC International Congress—Crop Science & Technology 2003, 267-272) published research that indicates that herbicide efficacy from sprays produced from drift reduction nozzles was lower than that from sprays produced from conventional flat-fan nozzles. However, other published information suggests that efficacy with coarser sprays produced from drift reducing nozzles can be as good as with finer sprays produced from conventional flat-fan nozzles, although efficacy can be lower from coarser sprays. It would be desirable to develop adjuvant formulations that minimize any decrease in efficacy when drift-reducing nozzles are used to apply the spray mixture.

The uniformity of herbicide deposition from coarse sprays may be one of the most important factors determining the degree of weed control obtained (Jensen P K; Jorgensen L N; Kirknel E (2001)—Biological Efficacy Of Herbicides And Fungicides Applied With Low-Drift And Twin-Fluid Nozzles: Crop Protection 20:57-64; Wolf T M (2000) Low-Drift Nozzle Efficacy With Respect To Herbicide Mode Of Action: Aspects of Applied Biology, 57, Pesticide Application, 29-34.

Cawood P N; Robinson T H; Whittaker S (1995)—An Investigation Of Alternative Application Techniques For The Control Of Blackgrass: Proceedings of the BCPC Conference—Weeds, 521-5280) determined that there was higher deposition or spray retention by Alopecurus myosuroides from finer sprays than from coarser sprays. Similar results were reported by Nilars M S; Taylor W A; Cooper S E; Taylor B. (2004)—Agrochemical Spray Accounting: The Use Of A Possible International Standard Protocol To Assess Interactions Of Spray Quality And Water Volume Rates On Target Plant Retention And Treatment Zone Losses: Aspects of Applied Biology, 71, International Advances in Pesticide Application, 9-17.

Richards M D; Holloway P J; Stock D. (1998)—Structure-Spray Retention Enhancement Relationships For Some Polymers And Polymeric Surfactants: Proceedings of the 5^{th} International Symposium for Adjuvants and Agrochemicals, Volume 1, 79-84, indicated that various polymeric additives can substantially increase spray retention. Other researchers have indicated that other additives can also improve spray retention. These additives have not previously been applied alone to enhance pesticide performance per se. The inclusion of these additives with currently used agricultural adjuvant compositions may enhance the efficacy of coarse sprays produced by drift reduction nozzles compared to the efficacy of coarse sprays containing adjuvant compositions which do not include these additives.

### SUMMARY OF THE INVENTION

The present invention involves both agricultural compositions and methods of application for producing and applying a composition, which enhances the efficacy of an agrochemical, applied through drift reduction nozzles to a desired substrate which can be a plant, soil or crop.

According to one aspect of the present invention, there is provided a method for enhancing the deposition and/or performance of an agrochemical on an agricultural substrate comprising applying to said agricultural substrate a sufficient amount of a composition in the form of a spray mixture comprising a block copolymer of polyoxyethylene and polyoxypropylene with a molecular weight ranging from 950 to 15,000 and an agrochemical by an air induction and/or other drift reduction spray apparatus.

In another aspect of the invention, there is provided a homogeneous, adjuvant or emulsifier concentrate composition comprising at least one block copolymer of polyoxyethylene and polyoxypropylene with a molecular weight from 950 to 15,000 and at least one member selected from the group consisting of

(i) vegetable oils, paraffinic oils;

(ii) carbon 4-22 carboxylic acids and blends thereof;

(iii) esterified carbon 4-22 carboxylic acids or blends thereof;

(iv) saponified carbon 4-22 carboxylic acids or blends thereof;

(v) N,N-dimethylamide of the formula
RCON(CH₃)₂
wherein R is an alkyl chain derived from a carboxylic acid having about 6 to about 18 carbon atoms; and
(vi) polybutenes of the following formula 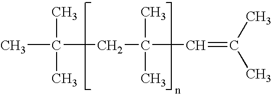
where n is a number from about 1 to about 50;
and/or at least one surfactant selected from the group consisting of
(a) fatty alkanolamides of the formula 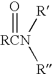
wherein R is an alkyl group having from about 6 to about 25 carbon atoms; R and R″ are the same or different and are independently selected from the group consisting of hydrogen,
—CH₂ CH₂OH and 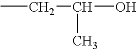
(b) PEG esters of the formula 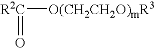
wherein R² is C₂-C₂₅ alkyl having from about 2 to about 25 carbon atoms, R³ is an alkyl having from about 2 to about 25 carbon atoms or hydrogen and m is a number from 1 to about 100,
(c) silicone surfactants of the formula 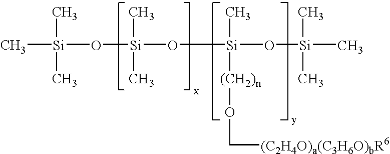
wherein x is a number from 0 to about 5, y is a number from 1 to about 5, a is a number from about 3 to about 25, b is a number from 0 to about 25, n is a number from about 2 to about 4 and R⁶ is hydrogen, an alkyl group having 1 to about 4 carbon atoms or an alkyl ester group having 1 to about 4 carbon atoms,
(d) ethoxylated carboxylic acids of the formula 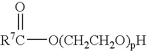
wherein R⁷ is an alkyl group having from about 6 to about 25 carbon atoms, p is a number from 1 to about 100,
(e) alkyl ethoxylates of the formula
R⁸O(CH₂CH₂O)_{q}H
wherein R⁸ is an alkyl group having from 1 to about 50 carbon atoms and q is a number from 1 to about 100,
(f) alkylphenol ethoxylates of the formula 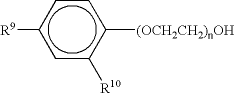
wherein R⁹ is hydrogen or an alkyl having from about 1 to about 20 carbons atoms, R¹⁰ is hydrogen or an alkyl having from about 1 to about 20 carbon atoms and n is a number from 1 to about 100;
(g) polypropylene glycols of the formula 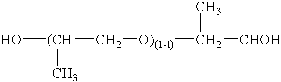
wherein t is a number from 1 to about 100,
(h) amine ethoxylates of the formula 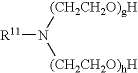
wherein g and h independently of one another are numbers from 1 to about 100 and R″ is an alkyl having from 1 to about 25 carbon atoms and
(i) tristyrylphenol alkoxylate;
(j) fatty alcohols
saturated or unsaturated, branch or linear C8-C20 alcohols.
(k) fatty ethers
are those generally derived from fatty alcohols characterized by the formula ROR wherein R is an alkyl group containing from 4 to 22 carbon atoms.
(l) glycerides
including those derived from glycerol and C6-C22 fatty acids,
optionally a buffering agent in an amount sufficient to buffer pH below about 9 and higher than 2;
and optionally a fertilizer maybe be present in the amount of 1.0% to 99%.

The acids and alcohols can be saturated or unsaturated.

### BRIEF DESCRIPTION OF THE DRAWING

The present invention will be further understood with reference to the accompanying drawing, which shows a typical air induction nozzle that can be used according to the present invention.

### DETAILED DESCRIPTION OF INVENTION

The agricultural composition that forms an enhanced activity when added to the spray tank is an adjuvant that may contain base oils as are commonly used in oil concentrates such as vegetable oils, paraffinic oils, esterified seed oils, natural seed oils, synthetic paraffinic oils, mono, di and tri carboxylic acids including fatty acids, low HLB surfactants, and other hydrophobic entities. The adjuvant also may contain nonionic surfactants, anionic surfactants, cationic surfactants, organosilicones, quaternary compounds, and other surface-active agents. The adjuvant also may contain plant nutrients such as nitrogen compounds, phosphorous compounds, potassium compounds, and minor elemental compounds of zinc, iron, manganese, magnesium, boron, etc. The adjuvant also may contain other functional agent including but not limited to defoamers, humcents, and polymers. The adjuvant composition is normally supplied as a concentrate that is then diluted when ready for spraying with the agrochemical.

As mentioned above, the present invention relates to an agricultural composition that exhibits enhanced biological performance when applied through drift reducing nozzles when formulated containing a polymeric surfactant in addition to the typical components of that type of agricultural composition. One such polymeric surfactant is comprised of blocks of ethylene oxide and propylene oxide of varying arrangements of the ethylene oxide and propylene oxide blocks and of varying total molecular weight of the polymer. When the block copolymer is applied to the agricultural substrate, it is present in an amount of 0.0001 to 10% by weight of the spray mixture. The pH of the spray mixture is from 2 to 10.

The accompanying drawing depicts a typical air induction nozzle (1) having two feed lines (2,3) for feeding the adjuvant and agrochemical respectively. The spray liquid (4) enters the nozzle body (5) and passes through the venture valve section (6) where air is introduced. The air liquid mixture passes to the mixing chamber and then out through tip orifice 8.

The following data shows the effect on weed kill of various formulations on specific weed populations.

TABLE 1
Velvetleaf control 28 days after treatment with glyphosate (0.375 lb ae/ac) as
influenced by nozzle type and adjuvants.

AX-0435-Polyoxyethylene polyoxypropylene block-co polymer average molecular
weight 2450-100.0%
AX-0240-Nonyl Phenol 9-40.0%, Fatty alcohol ethoxylate 2 mole-10.0%
Tall oil fatty acid-15.0%, Glycol 25%, and water 10.0%
AX-0417-Polyoxyethylene polyoxypropylene block-co polymer average molecular
weight 2450-25.0%, Glycol-40.0%, Water-10.0%, and Nonyl phenol 9 mole-
25.0%
AX-0438-PEG-400-25.0%, tallow amine ethoxylate 20 mole-70.0%, water-5.0%
AX-0434-PEG-400-18.75%, tallow amine ethoxylate 20 mole-52.5%, water-3.75%,
Polyoxyethylene polyoxypropylene block-co polymer average molecular weight
2450-25.0%
AX-0437-alkyl polyglycoside C9-11 Degree of polymerization of 1.6-100.0%
AX-0439-Polyoxyethylene polyoxypropylene block-co polymer average molecular
weight 2450-39.0, Glycol-15.0%, Water-5.0%, alkyl polyglycoside C9-11 Degree of
polymerization of 1.6-40.0%
AX-0423-Ethoxylated IsoDecyl Alcohol, POE 6-18.0%, Phosphate Ester of nonylphenol
POE 4-10.0%, Glycol-3%, Tallow amine ethoxylate 20 mole-16.0%, Water-20.0%,
Citric acid (50% soulution)-16.0%, Phosphoric acid (85% soultion)-4.0%, Potassium
hydroxide (50% soultion)-4.0%, alkyl polyglycoside C8-10 Degree of polymerization
of 1.7-6.0%, Polyacrylic acid sodium salt-3.0%
AX-0436-Polyoxyethylene polyoxypropylene block-co polymer average molecular
weight 2450-24.0%, Phosphate Ester of nonylphenol POE 4-10.0%, Tallow amine
ethoxylate 20 mole-16.0%, Water-20.0%, Citric acid (50% soulution)-16.0%,
Phosphoric acid (85% soultion)-4.0%, Potassium hydroxide (50% soultion)-4.0%,
alkyl polyglycoside C8-10 Degree of polymerization of 1.7-6.0%,

| Adjuvant | XR110015 Nozzle | InJet 110015 Nozzle |
|---|---|---|
| None | 83 | 85 |
| AX-0435 | | 89 |
| AX-0240 | 85 | 89 |
| AX-0417 | | 89 |
| AX-0438 | | 87 |
| AX-0434 | | 89 |
| AX-0437 | | 87 |
| AX-0439 | | 87 |
| AX-0423 | 80 | 83 |
| AX-0436 | | 89 |
| LSD (0.10) | | 3 |

The numbers in this table are percent control or percent kill of the weed.

TABLE 2
Hemp sesbania control 28 days after treatment with glyphosate (0.375 lb
ae/ac) as influenced by nozzle type and adjuvants.

| Adjuvant | XR110015 Nozzle | InJet 110015 Nozzle |
|---|---|---|
| None | 41 | 20 |
| AX-0435 | | 71 |
| AX-0240 | 70 | 41 |
| AX-0417 | | 50 |
| AX-0438 | | 43 |
| AX-0434 | | 71 |
| AX-0437 | | 75 |
| AX-0439 | | 73 |
| AX-0423 | 59 | 64 |
| AX-0436 | | 72 |
| LSD (0.10) | | 15 |

TABLE 3
Johnson grass control 28 days after treatment with foramsulfuron (0.8 oz/ac) by nozzle type and
adjuvants.

AX-0240-Nonyl Phenol 9-40.0%, Fatty alcohol ethoxylate 2 mole-10.0%
Tall oil fatty acid-15.0%, Glycol 25%, and water 10.0%
AX-0417-Polyoxyethylene polyoxypropylene block-copolymer average molecular
weight 2450-25.0%, Glycol-40.0%, Water-10.0%, and Nonyl phenol 9 mole-
25.0%
AX-0416-Nonyl Phenol 9-3.6%, Nonyl Phenol 6-2.72%, Tall oil fatty acid-10.0%,
water-0.68%, paraffinic oil-83.0%
AX-0418-Polyoxyethylene polyoxypropylene block-copolymer average molecular
weight 2450-12.5%, Sorbitan Sesquiolate-20.0%, paraffinic oil-50.0%, Nonyl Phenol
9-5.0%, Nonyl Phenol 6-4.0%, Tall oil fatty acid-3.5%, water-2.0%, Ethoxylated C6-
12 alcohol POE 3-3.0%
AX-0322-Ethoxlyated Rapseed oil POE 10-100%
AX-0419-Polyoxyethylene polyoxypropylene block-co polymer average molecular
weight 2450-25.0%, Glycol-35.0%, Ethoxlyated Rapseed oil POE 10-40.0%
AX-0318-Nonyl Phenol 9-4.0%, Nonyl Phenol 6-8.0%, Tall oil fatty acid-2.0%, methyl soyate-
81.0%, paraffinic oil-5.0%
AX-0420-Nonyl Phenol 9-1.0 %, Nonyl Phenol 6-9.0 %, methyl soyate-80.0%, Ethoxlyated
Rapseed oil POE 10-10.0%
AX-0329-methyl soyate-90.0%, Ethoxlyated Rapseed oil POE 10-10.0%
AX-0421-Ethoxlyated Rapseed oil POE 10-10.0%, Polyoxyethylene polyoxypropylene block-co
polymer average molecular weight 2450-12.5%, water-1.0%, Nonyl Phenol 9-
1.0 %, Nonyl Phenol 6-9.0 %, methyl soyate-66.5%

| Adjuvant | XR110015 Nozzle | InJet 110015 Nozzle |
|---|---|---|
| AX-0240 | 53 | 36 |
| AX-0417 | | 78 |
| AX-0416 | 74 | 45 |
| AX-0418 | | 79 |
| AX-0322 | 76 | 70 |
| AX-0419 | | 81 |
| AX-0318 | 86 | 73 |
| AX-0420 | | 86 |
| AX-0329 | 86 | 80 |
| AX-0421 | | 86 |
| LSD (0.10) | | 9 |

TABLE 4
Foxtail millet control 28 days after treatment with foramsulfuron
(0.8 oz/ac) by nozzle type and adjuvants.

| Adjuvant | XR110015 Nozzle | InJet 110015 Nozzle |
|---|---|---|
| AX-0240 | 40 | 49 |
| AX-0417 | | 70 |
| AX-0416 | 67 | 56 |
| AX-0418 | | 76 |
| AX-0322 | 69 | 66 |
| AX-0419 | | 84 |
| AX-0318 | 83 | 81 |
| AX-0420 | | 89 |
| AX-0329 | 86 | 79 |
| AX-0421 | | 88 |
| LSD (0.10) | | 10 |

TABLE 5
Velvetleaf control 28 days after treatment with glyphosate (0.375 lb ae/ac)
as influenced by nozzle type and adjuvants.

AX-0435-Polyoxyethylene polyoxypropylene block-co polymer average
molecular weight 2450-100.0%
AX-0240-Nonyl Phenol 9-40.0%, Fatty alcohol ethoxylate 2 mole-10.0%
Tall oil fatty acid-15.0%, Glycol 25%, and water 10.0%
AX-0417-Polyoxyethylene polyoxypropylene block-co polymer average
molecular weight 2450-25.0%, Glycol-40.0%, Water-10.0%, and Nonyl
phenol 9 mole-25.0%
AX-0438-PEG-400-25.0%, tallow amine ethoxylate 20 mole-70.0%,
water-5.0%
AX-0434-PEG-400-18.75%, tallow amine ethoxylate 20 mole-52.5%,
water-3.75%, Polyoxyethylene polyoxypropylene block-co polymer
average molecular weight 2450-25.0%

| Adjuvant | XR110015 Nozzle | DR 110015 Nozzle |
|---|---|---|
| None | 87 | 90 |
| AX-0435 | | 92 |
| AX-0240 | 88 | 88 |
| AX-0417 | | 92 |
| AX-0438 | 89 | 93 |
| AX-0434 | | 92 |
| LSD (0.10) | | 3 |

TABLE 6
Hemp sesbania control 28 days after treatment with glyphosate
(0.375 lb ae/ac) as influenced by nozzle type and adjuvants.

| Adjuvant | XR110015 Nozzle | DR 110015 Nozzle |
|---|---|---|
| None | 67 | 50 |
| AX-0435 | | 78 |
| AX-0240 | 71 | 69 |
| AX-0417 | | 71 |
| AX-0438 | 70 | 58 |
| AX-0434 | | 73 |
| LSD (0.10) | | 7 |

As described herein the adjuvants of the present invention can contain surfactants, emulsifiers or other tank mix performance additives such as a drift reduction products, compatibility agents, stickers etc. The essential component of the invention is an adjuvant containing block copolymers of polyoxyethylene and polyoxypropylene with average molecular weights from 950 to 15,000.

These block copolymers are well known in the art and are sold, for example, by BASF Corporation as PLURONIC®, PLURONIC R®, and TETRONIC® surfactants. Product literature is available from BASF describing these products in detail. The block-copolymers may be arranged in four different ways:

1) the creation of a hydrophobe of desired molecular weight by the controlled addition of propylene oxide to the two-hydroxyl groups of the propylene glycol. Ethylene oxide is then added to sandwich this hydrophobe between hydrophilic groups, controlled by length to constitute from 10% to 80% (by weight) of the final molecule.

2) reverse block-copolymers are prepared by adding ethylene oxide to ethylene glycol to provide a hydrophile of designated molecular weight. Propylene oxide is then added to obtain hydrophobic blocks on the outside of the molecule.

3) tetra-functional block copolymers derived from the sequential addition of propylene oxide and ethylene oxide to ethylenediamine; and

4) reverse tetra-functional block copolymers are produced by the sequential addition of ethylene oxide and propylene oxide to ethylenediamine.

The adjuvant composition of the present invention is a combination of at least one block copolymer describe above, an oil component, and/or surfactants (nonionic, anionic surfactants, cationic surfactants) and/or fertilizer component. The fertilizer can be present in an amount of 0.0001 to 99% by weight of the final spray mixture. The final spray mixture also contains water and the block copolymer and water are present in a weight ration of 1:10 to 1:10,000.

Suitable oil components included those selected from the group consisting of fatty carboxylic acid esters, seed oils, petroleum oils, mono, di or tricarboxylic acids, fatty alcohols, fatty ethers, fatty amides, synthetic oils and mixtures thereof.

Monocarboyxlic acid esters, which may be used, are those having the general formula:
R₂COOC_{N}H2_{N+1}
wherein R₂ is an alkyl radical having from about 4 to about 22 carbon atoms, and n is a number from 1-4. They are derived by the esterification of a carboxylic acid with an alkanol. Preferred fatty acid esters are methyl and ethyl esters derived from the esterification of unsaturated carboxylic acids having from about 18 to 22 carbon atoms. Particularly preferred methyl esters include methyl oleate, methyl laurate and methyl soyate. Preferred ethyl esters include ethyl oleate and ethyl canolate. Suitable fatty acids from which the fatty acid esters may be derived include, but are not limited to, coconut and other vegetable oils, tallow, etc. Di and tricarboxylic acids can also be used to form esters.

Alkoxylated carboxylic acid esters may also be employed. These include fatty acid esters such as those listed above which are alkoxylated with ethylene oxide, propylene oxide and combinations thereof.

Alcohols, which may be employed in the present invention, are saturated or unsaturated, branch or linear C8-C20 alcohols.

The carboxylic acids which may be employed in the present invention are those composed of a chain of alkyl groups containing from 4 to 22 carbon atoms and characterized by a terminal carboxyl group. The acids may be saturated such as, for example, butyric, lauric, palmitic and stearic or unsaturated such as, oleic, linoleic and linolenic.

The fatty ethers, which may be employed, are those generally derived from fatty alcohols, such as those listed above, by the elimination of water. They are generally characterized by the formula ROR wherein R ia an alkyl group containing from 4 to 22 carbon atoms.

Similarly, the fatty amides which may also be employed are those characterized by the general formula R=CONH₂ wherein R is an alkyl group having from 4-22 carbon atoms.

Suitable seed oils are those derived from seeds and nuts and included, but are not limited to, castor, coconut, soybean, and the like. Preferred seed oil includes soybean oil.

Useful petroleum oil includes, but is not limited to, petroleum, petroleum-derived oils and synthetic oils.

Suitable glycerides include those derived from glycerol and C6-22 fatty acid. Preferred glycerides include glycerol mono/di oleate.

Suitable nonionic surfactants for the use in the present invention include sugar surfactants, alkoxylated fatty alcohols, alkoxylated fatty acids, alkoxylated fatty acids, alkoxylated fatty ethers, alkoxylated fatty amides, ethoxylated seed oils, ethoxylated mineral oils, nonylphenol ethoxylates, alkoxylated alkyl phenols, ethoxylated glycerides, castor oil ethoxylates, and mixture thereof.

Alkoxylated fatty alcohols include fatty alcohols such as those listed above which are alkoxylated with ethylene oxide, propylene oxide, and combinations thereof.

Alkoxylated fatty acids include fatty acids such as those listed above which are alkoxylated with ethylene oxide, propylene oxide and combinations thereof.

Alkoxylated fatty ethers include fatty ethers such as that list above, which are alkoxylated with ethylene oxide, propylene oxide and combinations thereof.

Alkoxylated fatty amides include fatty amides such as those listed above which are alkoxylated with ethylene oxide, propylene oxide and combinations thereof.

Suitable alcohols ethoxylates included C8-18 alcohols ethoxylated with from about 2 to about 30 moles of ethylene oxide.

Suitable ethoxylated seed oils include those containing from about 1 to about 200 moles of ethylene oxide.

Suitable nonylphenol ethoxylates include those ethoxylated with about 4 to about 70 moles of ethylene oxide. A particularly preferred nonylphenol ethoxylated is a combination of a NP-9 with an NP-6.

Surfactants that also may be employed are, but are not limited to, quaternary ammonium surfactants, ether amine surfactants, alkoxylated amine surfactants, secondary or tertiary alcohol surfactants, sorbitan fatty acid ester and amine, organosilicone surfactants; phosphate esters and alkyl polyglycosides.

Further variations and modifications of the foregoing will be apparent to those skilled e intended to be encompassed by the claims appended hereto.

We claim:

1. A method for enhancing the deposition and/or performance of an agrochemical onto an agricultural substrate comprising:
applying to said agricultural substrate a sufficient amount of an adjuvant composition in the form of a spray mixture comprising a block copolymer of polyoxyethylene and polyoxypropylene with a molecular weight ranging from 950 to 15,000 and an agrochemical by an air induction and/or other drift reduction spray.

2. A method for treating an agricultural substrate comprising:
contacting said substrate with an agrochemical composition comprising an agrochemical and a block copolymer and water by spraying said composition onto said substrate using an air induction nozzle and/or other drift reduction nozzle.

3. The method according to claim 2, wherein the block copolymer has a molecular weight in the range of 950 to 15,000.

4. The method of claim 1, wherein the spray additionally contains a herbicide, a crop oil concentrate or vegetable oil and/or modified vegetable oil concentrate.

5. The method of claim 1, wherein the spray additionally contains a surfactant.

6. The method according to claim 1, wherein the block copolymer is present in the amount of 0.0001 to 10% by weight of said spray mixture.

7. The method according to claim 1, wherein the pH of the spray mixture is from 2 to 10.

8. The method according to claim 1, wherein a fertilizer is present in the amount of 0.0001 to 99% by weight of the spray mixture containing said block copolymer.

9. The method according to claim 1, wherein the block copolymer and water are present in a weight ratio of 1:10 to 1:10,000.

10. A method for treating an agricultural substrate in the form of vegetation or soil comprising:
providing an agrochemical composition in the form of a spray mixture containing a block copolymer of polyoxyethylene and polyoxypropylene, an agrochemical, water, a surfactant and at least one of a vegetable oil, modified vegetable oil, modified oil, natural oil or a paraffin oil,
applying said agrochemical composition to said substrate by spraying a sufficient amount of said composition onto said substrate by air induction and or other drift reducing spray means.

11. The method according to claim 10, wherein said spray mixture further contains a defoamer.

12. The method according to claim 1, wherein said spray contains at least one member selected from the group consisting of
(i) vegetable oils, seed oils, paraffinic oils;
(ii) carbon 4-22 carboxylic acids and blends thereof;
(iii) esterified carbon 4-22 carboxylic acids or blends thereof;
(iv) saponified carbon 4-22 carboxylic acids or blends thereof;
(v) N,N-dimethylamide of the formula
RCON(CH₃)₂
wherein R is an alkyl chain derived from a carboxylic acid having about 6 to about 18 carbon atoms; and
(vi) polybutenes of the following formula 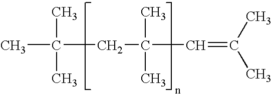
where n is a number from about 1 to about 50;
and/or at least one surfactant selected from the group consisting of
(a) fatty alkanolamides of the formula 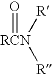
wherein R is an alkyl group having from about 6 to about 25 carbon atoms; R and R″ are the same or different and are independently selected from the group consisting of hydrogen,
—CH₂ CH₂OH and 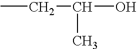
(b) PEG esters of the formula 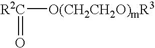
wherein R² is C₂-C₂₅ alkyl having from about 2 to about 25 carbon atoms, R³ is alkyl having from about 2 to about 25 carbon atoms or hydrogen and m is a number from 1 to about 100,
(c) silicone surfactants of the formula 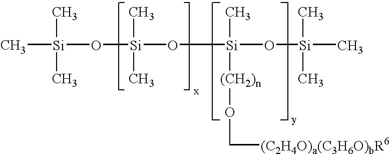
wherein x is a number from 0 to about 5, y is a number from 1 to about 5, a is a number from about 3 to about 25, b is a number from 0 to about 25, n is a number from about 2 to about 4 and R⁶ is hydrogen, an alkyl group having 1 to about 4 carbon atoms or an alkyl ester group having 1 to about 4 carbon atoms,
(d) ethoxylated carboxylic acids of the formula 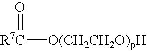
wherein R⁷ is an alkyl group having from about 6 to about 25 carbon atoms, p is a number from 1 to about 100,
(e) alkyl ethoxylates of the formula
R⁸O(CH₂CH₂O)_{q}H
wherein R⁸ is an alkyl group having from 1 to about 50 carbon atoms and q is a number from 1 to about 100,
(f) alkylphenol ethoxylates of the formula 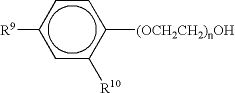
wherein R⁹ is hydrogen or an alkyl having from about 1 to about 20 carbons atoms, R¹⁰ is hydrogen or an alkyl having from about 1 to about 20 carbon atoms and n is a number from 1 to about 100;
(g) polypropylene glycols of the formula 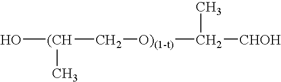
wherein t is a number from 1 to about 100,
(h) amine ethoxylates of the formula 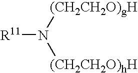
wherein g and h independently of one another are numbers from 1 to about 100 and R″ is an alkyl having from 1 to about 25 carbon atoms and
(i) tristyrylphenol alkoxylate;
(j) fatty alcohols
saturated or unsaturated, branch or linear C₈-C₂₀ alcohols.
(k) fatty ethers
are those generally derived from fatty alcohols characterized by the formula ROR wherein R ia an alkyl group containing from 4 to 22 carbon atoms.
(l) glycerides
include those derived from glycerol and C6-22 fatty acid, glycerides include glycerol mono/di oleate optionally a buffering agent in an amount sufficient to buffer pH below about 9 and higher than 2; and optionally a fertilizer maybe be present in the amount of 1.0% to 99%.

13. An adjuvant concentrate composition comprising at least one block copolymer of polyoxyethylene and polyoxypropylene with a molecular weight from 950 to 15,000 and at least one member selected from the group consisting of
(i) vegetable oils, seed oils, paraffinic oils;
(ii) carbon 4-22 carboxylic acids and blends thereof;
(iii) esterified carbon 4-22 carboxylic acids or blends thereof;
(iv) saponified carbon 4-22 carboxylic acids or blends thereof;
(v) N,N-dimethylamide of the formula
RCON(CH₃)₂
wherein R is an alkyl chain derived from a carboxylic acid having about 6 to about 18 carbon atoms; and
(vi) polybutenes of the following formula 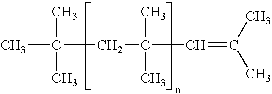
where n is a number from about 1 to about 50;
and/or at least one surfactant selected from the group consisting of
(a) fatty alkanolamides of the formula 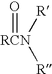
wherein R is an alkyl group having from about 6 to about 25 carbon atoms; R and R″ are the same or different and are independently selected from the group consisting of hydrogen,
—CH₂ CH₂OH and 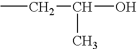
(b) PEG esters of the formula 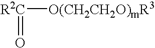
wherein R² is C₂-C₂₅ alkyl having from about 2 to about 25 carbon atoms, R³ is alkyl having from about 2 to about 25 carbon atoms or hydrogen and m is a number from 1 to about 100,
(c) silicone surfactants of the formula 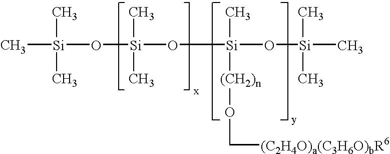
wherein x is a number from 0 to about 5, y is a number from 1 to about 5, a is a number from about 3 to about 25, b is a number from 0 to about 25, n is a number from about 2 to about 4 and R⁶ is hydrogen, an alkyl group having 1 to about 4 carbon atoms or an alkyl ester group having 1 to about 4 carbon atoms,
(d) ethoxylated carboxylic acids of the formula 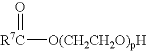
wherein R⁷ is an alkyl group having from about 6 to about 25 carbon atoms, p is a number from 1 to about 100,
(e) alkyl ethoxylates of the formula
R⁸O(CH₂CH₂O)_{q}H
wherein R⁸ is an alkyl group having from 1 to about 50 carbon atoms and q is a number from 1 to about 100,
(f) alkylphenol ethoxylates of the formula 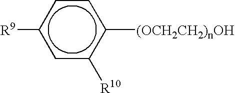
wherein R⁹ is hydrogen or an alkyl having from about 1 to about 20 carbons atoms, R¹⁰ is hydrogen or an alkyl having from about 1 to about 20 carbon atoms and n is a number from 1 to about 100;
(g) polypropylene glycols of the formula 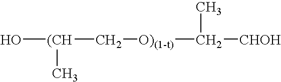
wherein t is a number from 1 to about 100,
(h) amine ethoxylates of the formula 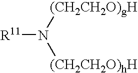
wherein g and h independently of one another are numbers from 1 to about 100 and R″ is an alkyl having from 1 to about 25 carbon atoms and
(i) tristyrylphenol alkoxylate;
(j) fatty alcohols
saturated or unsaturated, branch or linear C8-C20 alcohols.
(k) fatty ethers
are those generally derived from fatty alcohols characterized by the formula ROR wherein R ia an alkyl group containing from 4 to 22 carbon atoms.
(l) glycerides
include those derived from glycerol and C6-22 fatty acid, glycerides include glycerol mono/di oleate, optionally a buffering agent in an amount sufficient to buffer pH below about 9 and higher than 2; and optionally a fertilizer maybe be present in the amount of 1.0% to 99%.

14. The adjuvant concentrate composition as claimed in claim 13, wherein the buffering agent is selected from the group consisting of alkylaryl polyethoxy phosphate ester, C₁-C₆ carboxylic acids, C₁-C₆ dicarboxylic acids, phosphoric acid, citric acid, glutaric acid, gluconic acid, lactic acid, glycolic acid, acrylic acid, and carboxylated alcohol ethoxylate.

15. A spray composition comprising the adjuvant composition of claim 13 blended with an agrochemical and water to form a sprayable composition.

16. A method of making an adjuvant concentrate to be blended with an agrochemical for spraying out an agricultural substrate comprising mixing a block copolymer of polyoxyethylene and polyoxypropylene with a member selected from the group consisting of an oil, a surfactant and mixtures thereof.

17. A pesticide formulation comprising a pesticide, water and a block copolymer of polyoxyethylene and polyoxypropylene.

18. The pesticide formulation of claim 17 which further contains an oil, a surfactant or mixture thereof.

19. A concentrate adjuvant composition comprising a block copolymer of polyoxyethylene and polyoxypropylene, and at least one of an oil and a surfactant.

20. A method for enhancing the deposition and/or performance of an agrochemical onto an agricultural substrate comprising:
introducing an adjuvant composition and an agrochemical separately into an air induction nozzle to form a spray mixture inside said nozzle, introducing air into said nozzle and mixing said air and spray mixture inside said nozzle,
spraying said agricultural substrate with said spray mixture, said adjuvant composition comprising a block copolymer of polyoxyethylene and polyoxypropylene with a molecular weight ranging from 950 to 15,000.

21. The method according to claim 20, wherein the agrochemical is a pesticide.

22. The method according to claim 20, wherein the spray mixture additionally contains a crop oil concentrate or vegetable oil and/or modified vegetable oil concentrate.

23. The method according to claim 20, wherein the spray additionally contains a surfactant.

24. The method according to claim 20, wherein the block copolymer is present in the amount of 0.0001 to 10% by weight of said spray mixture.

25. The method according to claim 20, wherein the pH of the spray mixture is from 2 to 10.
